(19) United States
(12) Patent Application Publication
(10) Pub. No.: US 2016/0212829 A1
(43) Pub. Date: Jul. 21, 2016

(54) METHOD AND APPARATUS FOR INSTALLING AND OPERATING AN AUXILIARY LIGHTING SYSTEM USING A TRAILER PLUG

(71) Applicant: Meyer Products, LLC, Cleveland, OH (US)

(72) Inventor: Louis Orazem, Cleveland, OH (US)

(21) Appl. No.: 14/622,211

(22) Filed: Feb. 13, 2015

Related U.S. Application Data
(60) Provisional application No. 62/104,570, filed on Jan. 16, 2015.

(51) Int. Cl. H05B 37/02; B60Q 1/00; G08C 17/02; B60Q 1/34

(52) U.S. Cl. CPC H05B 37/0272; H05B 37/0263; B60Q 1/34; B60Q 1/0088; G08C 17/02

(57) ABSTRACT

An auxiliary lighting system using a trailer plug is disclosed. A signal may be transmitted from a trailer plug to an auxiliary implement attached to a vehicle. The signal can be sent through a wire or wirelessly using a transponder. In either case, the auxiliary lighting system does not require rewiring of the vehicle's wiring harness.

### TECHNICAL FIELD

This invention relates to a method for installing and operating an auxiliary lighting system using a vehicle's trailer plug.

### BACKGROUND

When an auxiliary implement, such as snowplow, is mounted onto the front of a vehicle, the headlights and turn signals are commonly obscured. Therefore, vehicle-mounted auxiliary implements normally include an auxiliary lighting system which includes headlights and turn signals which operate only when the vehicle's headlights and turn signals are obscured by the mounted implement.

Such auxiliary lighting systems typically and currently require a tie-in to the vehicle's electronic lighting system so that the auxiliary headlights and turn signals on the auxiliary implement can be coordinated, powered, and controlled by the vehicle's existing electrical system. Current installation techniques involve disconnecting the vehicle's original equipment manufacturer's (“OEM”) wiring harness and splicing or otherwise connecting the new wiring harness for the auxiliary lighting to the OEM wiring. This part of the process is can be labor intensive and objectionable as it requires altering the vehicle's existing electrical system. For example, the time necessary to initially install and mount a snowplow that utilizes an auxiliary lighting system to a vehicle is approximately four hours. The process of installing the wiring harness consumes approximately two and one half hours of that time. Therefore, a simpler installation process will reduce the amount of time and effort necessary to install an auxiliary implement utilizing an auxiliary lighting system and will eliminate the need for major alterations to the vehicle's OEM electrical systems.

Many vehicles that are suited to operate an auxiliary implement, such as a snowplow or spreader, are trucks that include trailer hitches that include a hitch receiver and a trailer plug. It is believed that approximately 95% of trucks currently manufactured feature trailer hitches. More recently, manufacturers offer trucks with towing packages, including a hitch receiver and a trailer plug, installed as standard equipment. Trucks that do not include these features as standard equipment from the manufacturer have the towing package available as an option from the factory. Vehicles other than trucks, such as cars and all-terrain vehicles (also known as “ATV's”) may also offer such hitch receivers and trailer plugs and may also be candidates for the herein disclosed invention.

“Trailer plugs” are a type of electric connector typically positioned at the rear end of trucks, such as a pickup truck, usually near a hitch receiver. Each trailer plug is positioned at one end of a trailer wiring harness. Trailer plugs come in multiple varieties and are designed to power and control trailer features such as brake lights, turn signals, running lights, and the like. The two most common trailer plugs are the 7-way plug and the 4-way plug. Many trucks now come with the 7-way plug installed from the factory, as discussed above. The 7-way plug typically includes wiring and connections for (1) the left turn signal, (2) the right turn signal, (3) the brake lights, (4) the ground wire, (5) the power brake wire, (6) a “hot” or auxiliary wire, and (7) the reverse lights. The auxiliary wire can be used to power internal lights, a trailer battery, a battery charger, or just about any other function requiring power. A 4-way plug typically has wires for both turn signals, brake lights, and the ground wire. Other common plugs include a 5-way and a 6-way plug, which add the power brake and auxiliary connections respectively. There are also a wide variety of European type trailer plugs with different wire configurations than those just described.

### SUMMARY

According to one embodiment of this invention, an auxiliary lighting system for use with an associated vehicle having a trailer plug; the auxiliary lighting system comprising:

A) an auxiliary implement having an auxiliary lighting system including at least one auxiliary light wherein the auxiliary implement is removably mounted to the associated vehicle having a trailer plug;

B) a transponder in electrical connection with the trailer plug wherein the transponder is capable of transmitting a wireless signal; and,

C) a receiver capable of receiving the wireless signal from the transponder to operate the auxiliary lighting system.

According to another embodiment of this invention, an auxiliary lighting system for use with an associated vehicle having a trailer plug; the auxiliary lighting system comprising:

A) an auxiliary implement having an auxiliary lighting system including at least one auxiliary light wherein the auxiliary implement is removably mounted to at least one of: (1) the associated vehicle's front; and, (2) at least one of the associated vehicle's sides; and wherein the associated vehicle has a trailer plug; and

B) a wire bundle secured to the vehicle and in electrical connection with the trailer plug and the auxiliary lighting system; wherein the wire bundle can transmit an electrical signal from the trailer plug to the auxiliary lighting system to operate the auxiliary lighting system.

According to yet another embodiment of this invention, an auxiliary lighting system for use with an associated vehicle having a trailer plug; the auxiliary lighting system comprising:

A) an auxiliary implement having an auxiliary lighting system including at least one auxiliary light; at least one turn signal; wherein the auxiliary implement is removably mounted to at least one of: (1) the associated vehicle's front; and, (2) at least one of the associated vehicle's sides; and wherein the associated vehicle has a braking system including a brake pedal and brake lights and a trailer plug;

B) a wire bundle secured to the vehicle and in electrical connection with the trailer plug and the auxiliary lighting system; wherein the wire bundle can transmit an electrical signal from the trailer plug to the auxiliary lighting system to operate the auxiliary lighting system;

wherein the wire bundle is electrically connected to the auxiliary lighting system in a manner sufficient to illuminate the at least one turn signal when the brake pedal of the associated vehicle is depressed.

According to yet another embodiment of this invention, a transponder may include: a housing;

a transponder plug supported to the housing that is adapted to electrically connect to an associated trailer plug; a receiving unit supported to the housing that is adapted to receive an electric signal from the associated trailer plug; a processing unit supported to the housing that interprets the electric signal and creates a corresponding control signal; and, a communication unit supported to the housing that communicates the control signal wirelessly.

Benefits and advantages of this invention will become apparent to those skilled in the art to which it pertains upon reading and understanding of the following detailed specification.

### DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a side view of a vehicle with an associated implement and trailer hitch installed;

FIG. 2 is a view of an exemplary trailer hitch and trailer plug;

FIG. 3A is a close-up, end view of a 7-way plug;

FIG. 3B is a close-up, end view of a 6-way plug;

FIG. 3C is a close-up, end view of a 5-way plug;

FIG. 3D is a close-up, perspective view of a 4-way plug;

FIG. 4 is a perspective view of an auxiliary plug and wire bundle;

FIG. 5 is perspective view of one embodiment of a pigtail adapter;

FIG. 6 is a perspective view of a plow frame with a plow control unit installed;

FIG. 7 is a schematic representation of the plow control unit;

FIG. 8 is a perspective view of the rear of an associated vehicle, showing a transponder connected to a trailer plug;

FIG. 8A is a perspective view of a transponder;

FIG. 9 is a schematic representation of the transponder;

FIG. 10 is a perspective view of an embodiment of a vehicle chassis with the vehicle body removed; and,

FIG. 11 is a detailed view of a portion of a vehicle chassis showing the wire bundle attachment means.

### DETAILED DESCRIPTION

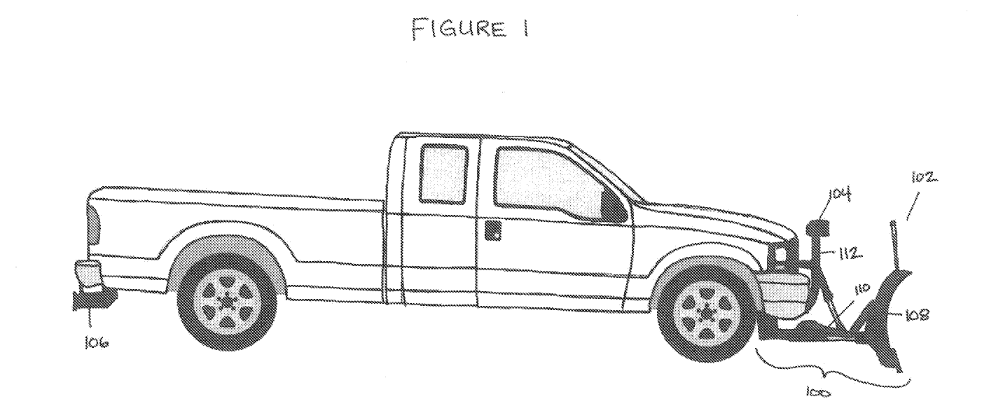

With reference to FIG. 1, an auxiliary implement 100 is shown installed on the front end of a vehicle having a trailer hitch 106 at its rear end. According to the embodiment shown, the auxiliary implement 100 is a snowplow assembly 102. This invention, however, may be used with other auxiliary implements chosen with the sound judgment of a person of skill in the art. The auxiliary implement 100 includes an auxiliary lighting system consisting of at least one auxiliary light 104. In other embodiments, the auxiliary implement 100 can be a vehicle-mounted device that uses or requires auxiliary lighting. Non-limiting examples of other snow and/or ice removal auxiliary implements that may be used with this invention include power brooms, sweepers, spreaders and the like. While the auxiliary implement 100 shown is mounted to the front of the vehicle, in other embodiments of the invention the auxiliary implement 100 can be mounted to the rear or sides of the associated vehicle, or a combination of the front, rear, and/or sides of the vehicle. For purposes of the remainder of this disclosure, the auxiliary implement 100 will be discussed as a snowplow assembly 102; however, all further embodiments disclosed are intended to be applicable to all embodiments as discussed above—including, where applicable, non-snow and/or ice removal auxiliary implements. As used herein, snowplow assembly 102 is interpreted to include the plow blade 108, the plow frame 110, the lift frame 112, and all parts associated therewith. The trailer hitch 106 can include factory-installed or aftermarket hitches, without limitation.

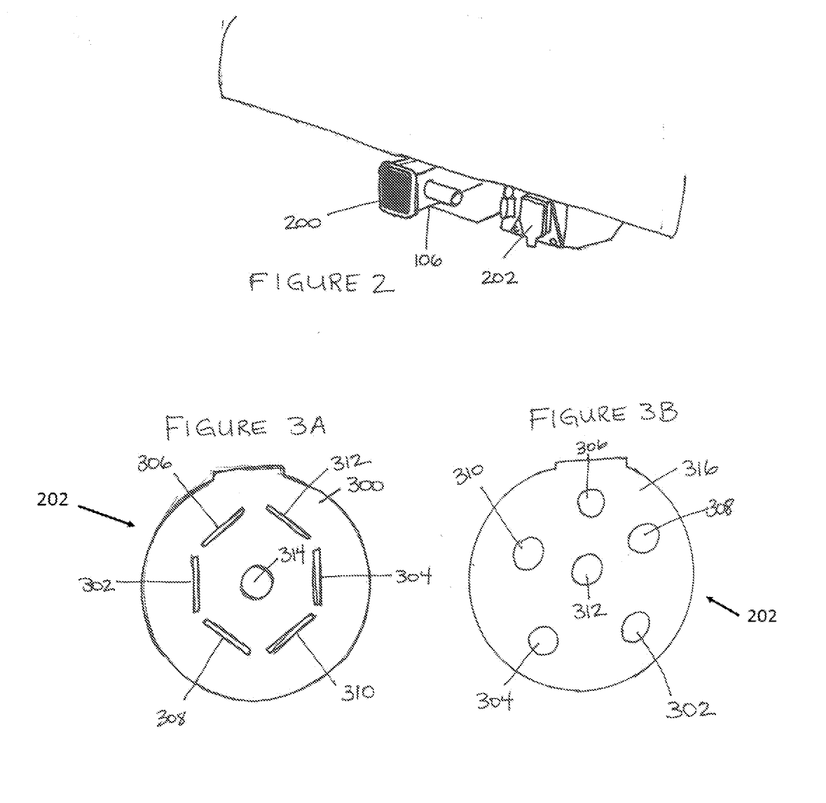

With reference to FIG. 2, an embodiment of the trailer hitch 106 is shown including a hitch receiver 200 and a trailer plug 202. The hitch receiver 200, as is well known to those of skill in the art, is a tube adapted to receive a portion of a trailer or other device so that the trailer or other device can be physically attached to the vehicle. The trailer plug 202, as is well known to those of skill in the art, is an electric plug. While trailer plugs ordinarily come with hitch receivers, as shown, it should be understood that a hitch receiver is not required for this invention. Also, while trailer plugs ordinarily are positioned at the rear ends of vehicles, as shown, it should be understood that the location of the trailer plug when used with this invention can be any location chosen with the sound judgment of a person of skill in the art.

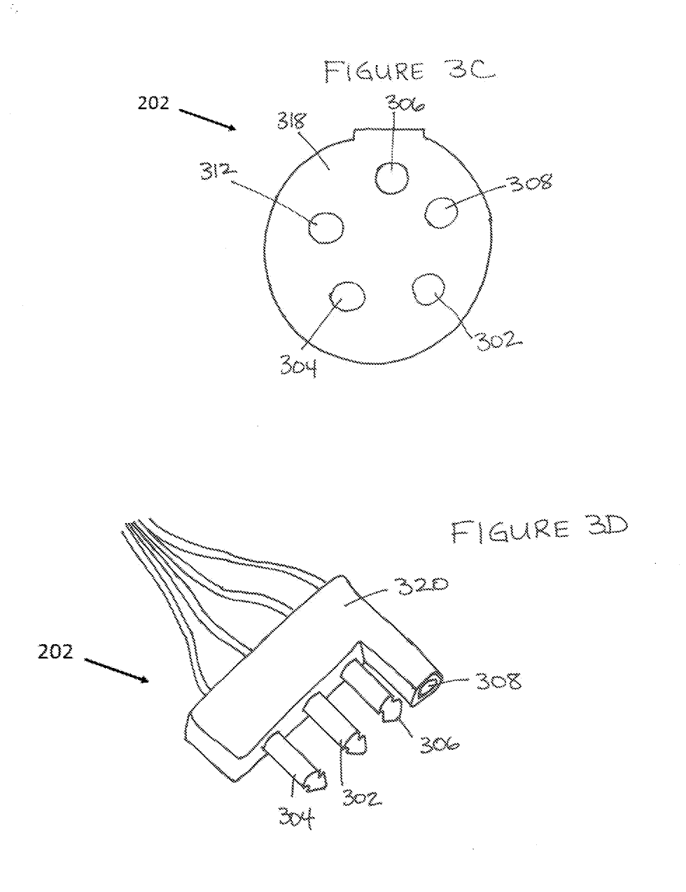

According to one embodiment, the trailer plug 202 can be a 7-way plug 300 (FIG. 3A). According to other embodiments, the trailer plug 202 can be a 6-way plug 316 (FIG. 3B), a S-way plug 318 (FIG. 3C), a 4-way plug 320 (FIG. 3D), or any other design including open wiring extending from the vehicle. The trailer plug 202 can be factory installed on the vehicle or it can be installed by an aftermarket or third party installer, without limitation. The location of the trailer plug 202 relative to the hitch receiver 200 is variable and can be chosen by a person of ordinary skill in the art. The trailer plug 202 can include a cover, as shown, but a cover is not required for this invention.

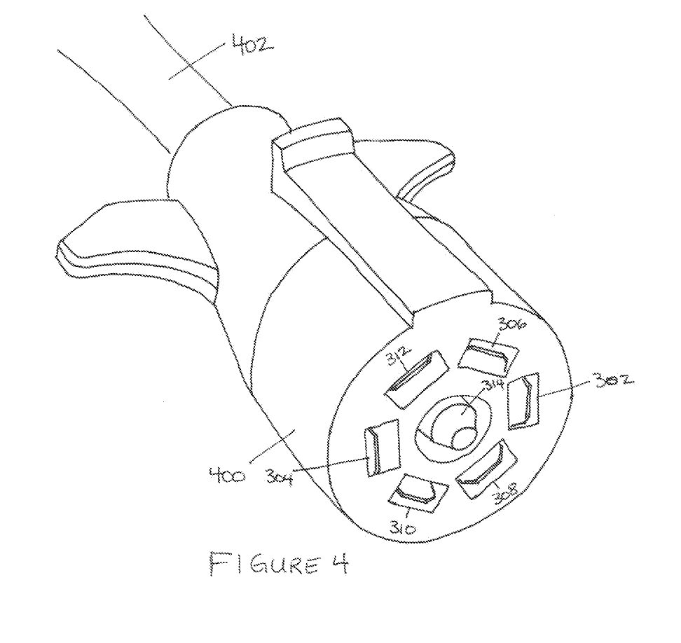

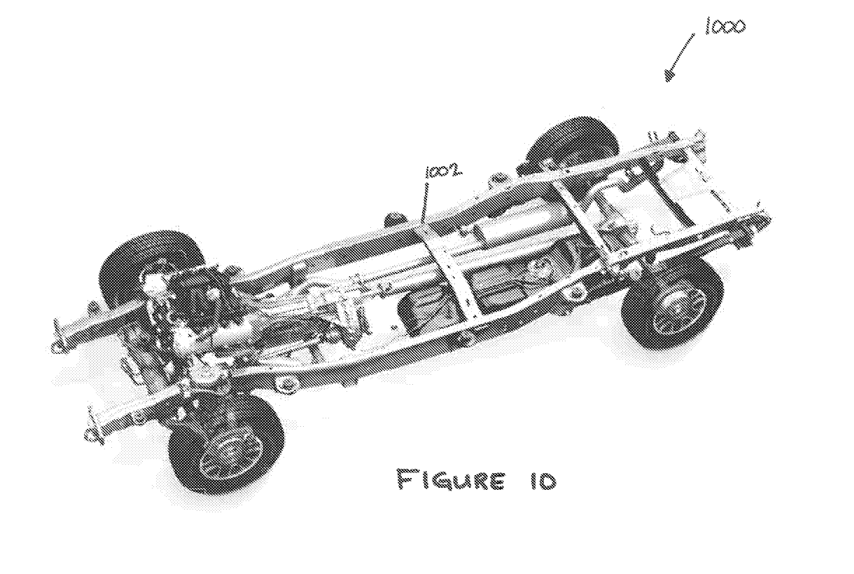

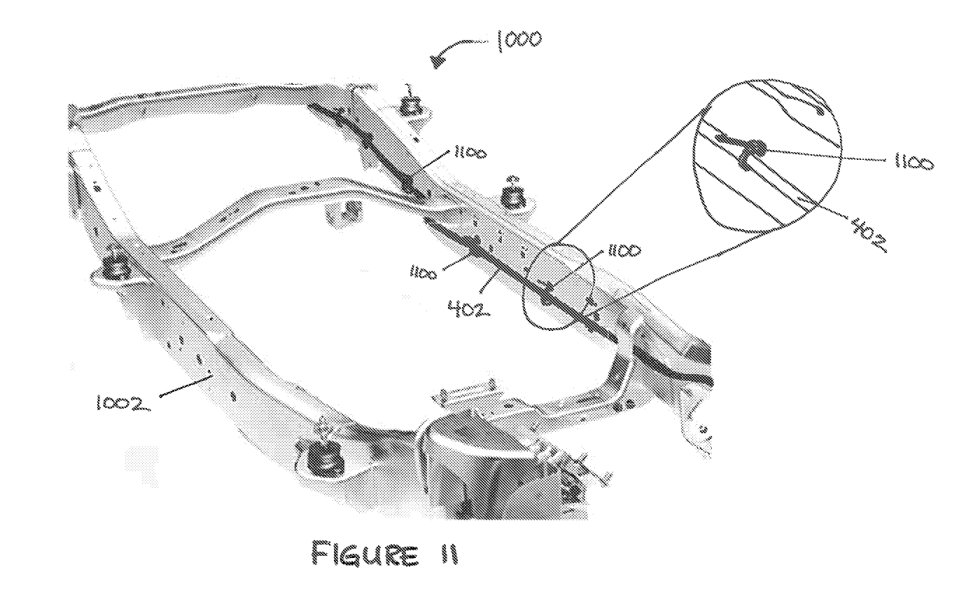

With reference to FIGS. 3A-3D, 4, 10, and 11, the auxiliary implement including an auxiliary lighting system, in this embodiment snowplow assembly 102, can include an auxiliary plug 400 that is adapted to be plugged into or connected to the trailer plug 202. The auxiliary plug 400 may be positioned at one end of a wire bundle 402. According to one embodiment, the auxiliary plug 400 can be a 7-way plug that connects to a 7-way plug 300 on the associated vehicle. A standard T-way plug 300 includes seven electrical connections with each of these connections providing power and control over one element of a trailer. The seven standard connections are (1) the left turn signal 302, (2) the right turn signal 304, (3) the brake lights 306, (4) the ground wire 308, (5) the power brake wire 310, (6) an auxiliary wire 312, and (7) the reverse lights 314. The arrangement of these connections can vary depending on the manufacturer of the trailer plug 202 but the types of connections are typical of most 7-way plugs 302. According to one embodiment, the auxiliary plug 400 can be configured to align with the 7-way plug 302 to connect the plow headlights, turn signals, plow functions and ground wires. Additional connections can be made depending upon the features present on the snowplow assembly 102. Any unused connections between the 7-way plug 302 and the auxiliary plug 400 can be repurposed or terminated, as determined by one of ordinary skill in the art. Once the trailer plug 202 and auxiliary plug 400 are connected, a wire bundle 402 can be routed under, through, around, or over the vehicle to connect to the snowplow 102. According to one embodiment, the wire bundle 402 is secured under the chassis 1000 of the vehicle and runs lengthwise from the rear of the vehicle to the front of the vehicle where it can terminate at the snowplow assembly 102. According to another embodiment, the wire bundle 402 can terminate at the front of the vehicle whereby a second connection could be made with the snowplow assembly 102 wiring system. The wire bundle can be secured to the chassis 1000 using zip-ties 1100, twist ties, wires, or any other fastener chosen by the sound judgment of a person of ordinary skill in the art. According to another embodiment, conduit can be mounted to the chassis 1000 using zip-ties 1100 or other fasteners. The wire bundle 402 can be routed through the conduit from the rear of the vehicle to the front of the vehicle. According to another embodiment, the wire bundle 402 can be routed through the interior of the vehicle's frame 1002.

With reference to FIGS. 3B-3D, vehicles featuring a 6-way plug 316 or a 5-way plug 318 could also be used with the disclosed system as the ground wire and turn signal connections would still be used and the remaining open connections could be used to power the auxiliary lighting system and the plow functions. A vehicle featuring a 4-way plug 320 could also be used; however it may require combining a function, e.g. powering plow functions and auxiliary lights from the same circuit, or by providing a separate power connection from the vehicle battery directly to one of the functions, e.g. the plow controls.

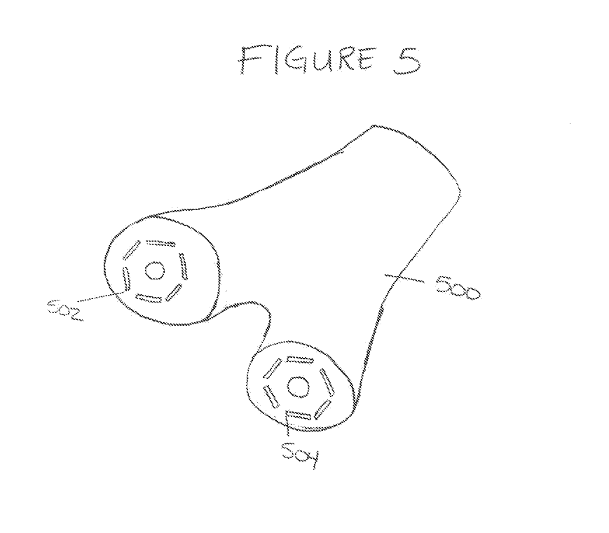

With reference to FIG. 5, a pigtail adapter 500 can be used between the trailer plug 202 and the auxiliary plug 400. The pigtail adapter 500 can split the connections from the trailer plug 200 into a first outlet 502 and a second outlet 504. The first and second outlets 502, 504 can be configured to allow connections for any of the various plug types. By way of a non-limiting example, the first outlet 502 can be a 7-way plug 300 while the second outlet 504 can be a 4-way plug 320. The combinations can be chosen by a person of ordinary skill in the art and can be tailored for specific needs given the desired usage. The pigtail adapter 500 can allow a person to connect the present invention while leaving an additional connection available for use with a trailer or second implement 100. According to one embodiment, the pigtail adapter 500 can have more than two outlets.

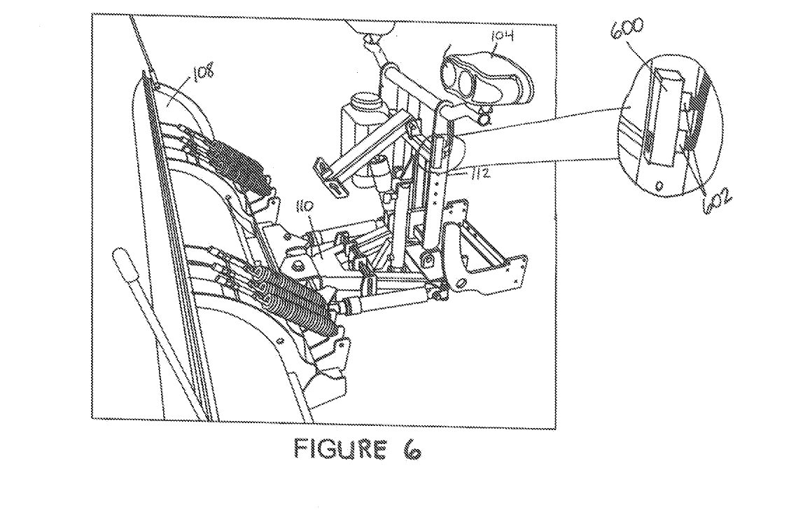

With reference to FIG. 6, according to one embodiment of the invention, a plow control unit (“PCU”) 600 can be mounted on the snowplow assembly 102. The PCU 600 can receive the wire bundle 402 from the vehicle, either directly or through the plow wiring system. According to alternative embodiments, the PCU 600 can be mounted within the housing of an auxiliary light 104, or on the associated vehicle, or within the engine compartment of the associated vehicle. The exterior of the PCU 600 can have one or more ports 602 to connect to the wiring system of the auxiliary lighting system.

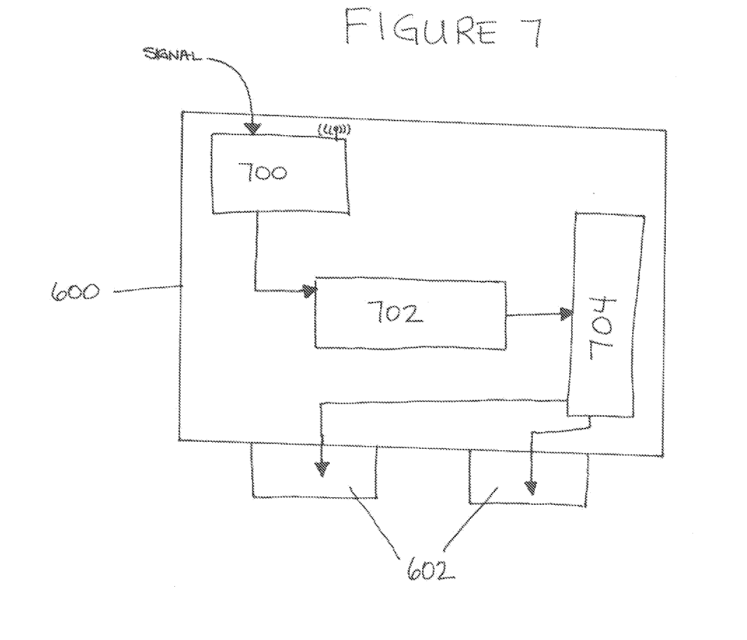

With reference to FIG. 7, the PCU 600 can include several circuits that can perform one or more functions. The PCU 600 includes a receiver 700 which receives incoming signals from the vehicle via the wire bundle 402. The receiver 700 then directs the signal to the microprocessor 702, which then uses the signal to determine which lights and plow functions are or should be powered, and then directs the signal out via a power distribution circuit 704 to the various systems accordingly. According to one embodiment, the receiver 700 can be a wireless receiver capable of receiving signals transmitted through radio frequency, WiFi, Bluetooth, or any other wireless transmission protocol. The receiver 700 can alternatively be adapted to receive signals from a wired connection, wirelessly, or both. The microprocessor 702 can detect which lights are illuminated and adjust the signal accordingly. For example, the microprocessor 702 can determine if the vehicle headlights are illuminated while the auxiliary lights 104 are not. In that instance, as it would be desirable to illuminate the auxiliary lights 104 rather than the vehicle headlights, the microprocessor 702 could adjust the signal to provide power to the auxiliary lights 104 and not to the vehicle headlights.

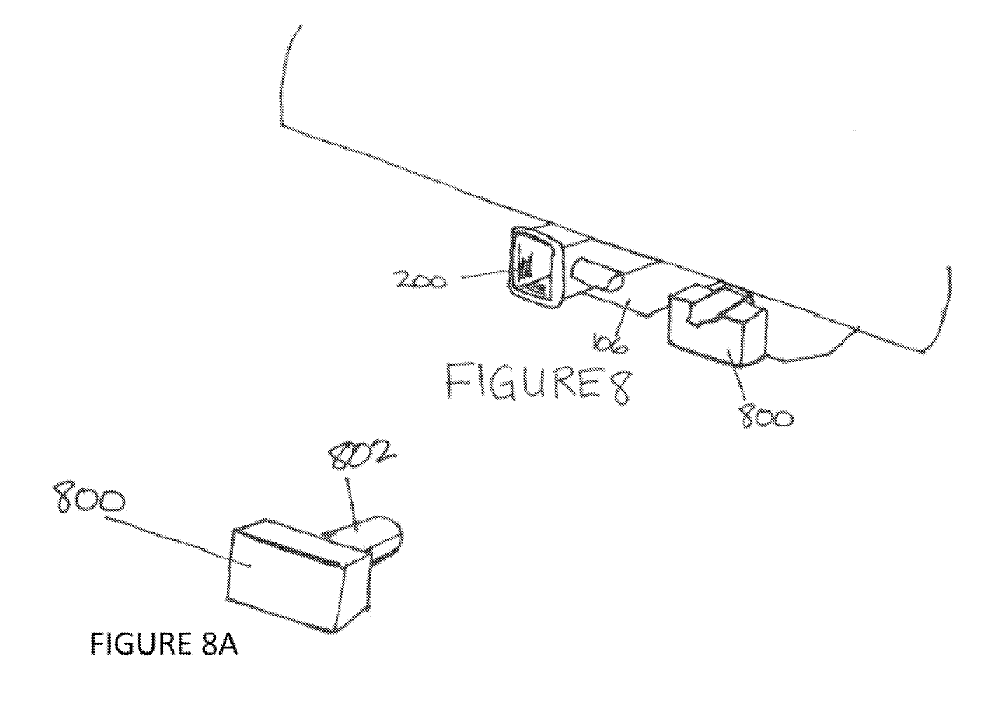

With reference to FIGS. 8 AND 8A, in another embodiment instead of a wire bundle, a transponder 800 may be used that connects to the vehicle via the trailer plug 202. The transponder 800 can include a transponder plug 802 which is the corollary to the auxiliary plug 400. The transponder plug 802 can be configured to connect to any of the trailer plug 202 types. According to one embodiment, the transponder plug 802 can be configured to align with the 7-way plug 302. Additional connections can be made depending upon the features present on the snowplow assembly 102. Any un-used connections between the 7-way plug 302 and the transponder plug 802 can be repurposed or terminated, as determined by one of ordinary skill in the art. According to other embodiments, the transponder plug 802 can be configured to connect to a 6-way plug 316, a 5-way plug 318, or a 4-way plug 320.

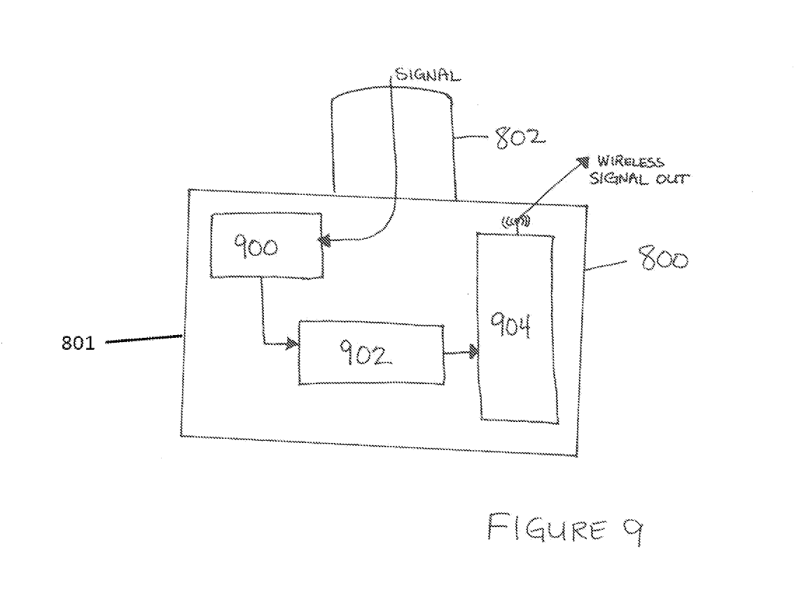

With reference to FIG. 9, the transponder 800 can include a housing 801 to which the transponder plug 802 is supported. The transponder 800 can also include several circuits that can perform one or more functions. The transponder 800 can, for example, include a receiving unit 900 which is supported to the housing 801 and which receives incoming signals from the vehicle via the trailer plug 202. The receiver then directs the signal to the processing unit 902 which is also supported to the housing 801. The processing unit 902 can interpret the signal to determine which lights/plow functions are or should be powered, and then direct the appropriate signal to the communication unit 904 which is also supported to the housing 801. The communication unit 904 can transmit a wireless signal to broadcast out. The wireless signal can be radio frequency, WiFi, Bluetooth, or any other wireless transmission protocol capable of being broadcast over a wide enough distance to reliably reach the snowplow assembly 102 situated in the front of the vehicle. The transponder 800 can draw power directly from the vehicle's power supply via the trailer plug 202. According to one embodiment, the transponder 800 can be mounted to the hitch receiver 200. According to another embodiment, the transponder 800 can be mounted on the vehicle itself. According to this embodiment wherein the transponder is used in place of the wire bundle, the transponder 800 severs the direct connection between the vehicle's power supply and the snowplow assembly 102. Therefore, an alternative power connection can be made to the snowplow assembly 102. According to one embodiment, a wire can be run from the vehicle battery directly to the snowplow assembly 102. According to another embodiment, the snowplow assembly 102 can include an independent power supply, such as a battery, that can be mounted on the snowplow assembly 102.

With reference to FIGS. 6-9, according to one embodiment, a vehicle is provided with an auxiliary snowplow assembly 102 attached at the front of the vehicle. The auxiliary plug 400 is connected to the trailer plug 202 and the wire bundle 402 is provided to connect the snowplow assembly 102 to the vehicle. A user can control the auxiliary lighting system by use of the standard in cab controls. For example, a user would power the vehicle headlights on using the in-cab headlight control. When a snowplow assembly 102 is installed on the vehicle, the signal to power the headlights travels through the vehicle's OEM wiring harness, and to the trailer plug 202. The corresponding wire within the trailer plug 202 becomes powered, or “hot,” which is an indication that the wire has a current running through it. This current then flows through the trailer plug 202 to the auxiliary plug 400 and out through the wire bundle 402 to the PCU 600. The receiver 700 within the PCU 600 directs the current to the microprocessor 702 within the PCU 600. The microprocessor 702 then determines which wire delivered the current, thereby determining which function should receive the power, for example, the headlights. The microprocessor 702 then directs the signal through the power distribution circuit 704, and the signal is sent out to power the headlights. When the user turns the circuit off, the microprocessor 702 detects that there is no longer current being supplied and sends a signal to the power distribution circuit 704 to stop powering the headlights.

With reference to FIGS. 3A-3D, 4, and 6-9, according to one embodiment, the auxiliary light system can include at least one headlight and at least one turn signal. According to one embodiment, the auxiliary plug 400 can connect to the trailer plug 202 in a way that connects the brake light 306 connection from the trailer plug 202 to the turn signal light or lights that can be provided as part of the auxiliary lighting system. In this embodiment, when a user depresses the brake pedal the turn signal(s) provided as part of the auxiliary lighting system can illuminate. This feature can be configured to allow the turn signal(s) provided as part of the auxiliary lighting system to illuminate continuously for the duration of the braking event. Alternatively, this feature can be configured to allow the turn signal(s) provided as part of the auxiliary lighting system to flash on and off for the duration of the braking event. This feature can indicate to observers in front of the vehicle that the vehicle is slowing and/or that they should exercise caution.

With continued reference to FIGS. 6-9, according to another embodiment, a transponder 800 can be used. The transponder 800 can be connected directly to the trailer plug 202. A user then connects an alternative power supply to the snowplow assembly 102, such as a direct line from the vehicle power supply or a secondary battery. When a user operates one of the in-cab controls, the current travels the same path to the trailer plug 202, just as before. According to this embodiment, once the current passes through the trailer plug 202, it enters the receiving unit 900 within the transponder 800. The receiving unit 900 within the transponder 800 directs the current to the processing unit 902 within the transponder 800. This processing unit 902 determines the origin of the current, thereby determining which function should receive power. The processing unit 902 then sends a signal to the communication unit 904. The communication unit 904 transmits the signal wirelessly to the PCU 600, which can be powered by the alternative power supply. The receiver 700 within the PCU 600 can receive the incoming wireless signal from the communication unit 904. The wireless signal is directed from the receiver 700 within the PCU 600 to the microprocessor 702 within the PCU 600. The microprocessor 702 interprets the wireless signal to determine which function should be powered and sends the appropriate signal to the power distribution circuit 704 to power the appropriate system.

As described above, the present disclosure has been described with preferred embodiments thereof and it is understood that many changes and modifications to the described embodiments can be carried out without departing from the scope and the spirit of the present disclosure that is intended to be limited only by the appended claims.

Having thus described the invention, it is now claimed:

1. An auxiliary lighting system for use with an associated vehicle having a trailer plug; the auxiliary lighting system comprising:
A) an auxiliary implement having an auxiliary lighting system including at least one auxiliary light wherein the auxiliary implement is removably mounted to the associated vehicle having a trailer plug;
B) a transponder in electrical connection with the trailer plug wherein the transponder is capable of transmitting a wireless signal; and,
C) a receiver capable of receiving the wireless signal from the transponder to operate the auxiliary lighting system.

2. The auxiliary lighting system of claim 1 wherein:
the associated vehicle has an OEM wiring harness; and,
neither installation of the auxiliary lighting system nor operation of the auxiliary lighting system requires rewiring the OEM wiring harness.

3. The auxiliary lighting system of claim 1 wherein:
the associated vehicle has a vehicle battery; and,
the auxiliary lighting system is powered by a wired connection directly to the vehicle battery.

4. The auxiliary lighting system of claim 1 wherein:
the associated vehicle has a vehicle battery; and,
the auxiliary lighting system is powered by an independent power supply that is not the vehicle battery.

5. The auxiliary lighting system of claim 1 wherein the auxiliary implement is a snow and/or ice removal auxiliary implement.

6. The auxiliary lighting system of claim 1 wherein the auxiliary implement is a snowplow assembly.

7. The auxiliary lighting system of claim 1 wherein the transponder comprises:
a housing;
a transponder plug supported to the housing that is electrically connected to the trailer plug;
a receiving unit supported to the housing that is adapted to receive an electric signal from the trailer plug;
a processing unit supported to the housing that interprets the electric signal and creates a corresponding control signal; and,
a communication unit supported to the housing that transmits the control signal wirelessly.

8. The auxiliary lighting system of claim 1 wherein the trailer plug is one of: a 7-way plug, a 6-way plug, a 5-way plug, and a 4-way plug.

9. The auxiliary lighting system of claim 1 wherein the auxiliary lighting system further comprises a pigtail adapter electrically connected between the trailer plug and the transponder.

10. The auxiliary lighting system of claim 9 wherein the pigtail adapter comprises a splitter having at least two outlets.

11. An auxiliary lighting system for use with an associated vehicle having a trailer plug; the auxiliary lighting system comprising:
A) an auxiliary implement having an auxiliary lighting system including at least one auxiliary light wherein the auxiliary implement is removably mounted to at least one of: (1) the associated vehicle's front; and, (2) at least one of the associated vehicle's sides; and wherein the associated vehicle has a trailer plug; and
B) a wire bundle secured to the vehicle and in electrical connection with the trailer plug and the auxiliary lighting system; wherein the wire bundle can transmit an electrical signal from the trailer plug to the auxiliary lighting system to operate the auxiliary lighting system.

12. The auxiliary lighting system of claim 11 wherein:
the associated vehicle has an OEM wiring harness; and,
neither installation of the auxiliary lighting system nor operation of the auxiliary lighting system requires rewiring the OEM wiring harness.

13. The auxiliary lighting system of claim 11 wherein the auxiliary implement is a snow and/or ice removal auxiliary implement.

14. The auxiliary lighting system of claim 11 wherein the auxiliary implement is a snowplow assembly.

15. The auxiliary lighting system of claim 11 wherein the trailer plug is one of: a 7-way plug, a 6-way plug, a 5-way plug, and a 4-way plug

16. The auxiliary lighting system of claim 11 wherein the auxiliary lighting system further comprises a pigtail adapter electrically connected between the trailer plug and the wire bundle.

17. The auxiliary lighting system of claim 16 wherein the pigtail adapter comprises a splitter having at least two outlets.

18. A transponder comprising:
a housing;
a transponder plug supported to the housing that is adapted to electrically connect to an associated trailer plug;
a receiving unit supported to the housing that is adapted to receive an electric signal from the associated trailer plug;
a processing unit supported to the housing that interprets the electric signal and creates a corresponding control signal; and,
a communication unit supported to the housing that communicates the control signal wirelessly.

19. The transponder of claim 18 wherein the receiving unit, the processing unit, and the communication unit are adapted to operate a snow and/or ice removal auxiliary implement.

20. The transponder of claim 18 wherein the receiving unit, the processing unit, and the communication unit are adapted to operate a snowplow assembly.

21. The transponder of claim 18 wherein the trailer plug is one of: a 7-way plug, a 6-way plug, a 5-way plug, and a 4-way plug.

22. An auxiliary lighting system for use with an associated vehicle having a trailer plug; the auxiliary lighting system comprising:
A) an auxiliary implement having an auxiliary lighting system including at least one auxiliary light; at least one turn signal; wherein the auxiliary implement is removably mounted to at least one of: (1) the associated vehicle's front; and, (2) at least one of the associated vehicle's sides; and wherein the associated vehicle has a braking system including a brake pedal and brake lights and a trailer plug;
B) a wire bundle secured to the vehicle and in electrical connection with the trailer plug and the auxiliary lighting system; wherein the wire bundle can transmit an electrical signal from the trailer plug to the auxiliary lighting system to operate the auxiliary lighting system;
wherein the wire bundle is electrically connected to the auxiliary lighting system in a manner sufficient to illuminate the at least one turn signal when the brake pedal of the associated vehicle is depressed.

23. The auxiliary lighting system of claim 22 wherein:
the associated vehicle has an OEM wiring harness; and,
neither installation of the auxiliary lighting system nor operation of the auxiliary lighting system requires rewiring the OEM wiring harness.

24. The auxiliary lighting system of claim 22 wherein the auxiliary implement is a snow and/or ice removal auxiliary implement.

25. The auxiliary lighting system of claim 22 wherein the auxiliary implement is a snowplow assembly.

26. The auxiliary lighting system of claim 22 wherein the trailer plug is one of: a 7-way plug, a 6-way plug, a 5-way plug, and a 4-way plug

27. The auxiliary lighting system of claim 22 wherein the auxiliary lighting system further comprises a pigtail adapter electrically connected between the trailer plug and the wire bundle.

28. The auxiliary lighting system of claim 27 wherein the pigtail adapter comprises a splitter having at least two outlets.

29. A wire bundle for use with an associated auxiliary lighting system, the auxillary lighting system adapted for use with an associated vehicle having a trailer plug; the auxiliary lighting system comprising an auxiliary implement having an auxiliary lighting system including at least one auxiliary light; at least one turn signal; wherein the auxiliary implement is removably mounted to at least one of: (1) the associated vehicle's front; and, (2) at least one of the associated vehicle's sides; and wherein the associated vehicle has a braking system including a brake pedal and brake lights and a trailer plug, the wire bundle comprising:
a wire bundle secured to the vehicle and in electrical connection with the trailer plug and the auxiliary lighting system; wherein the wire bundle can transmit an electrical signal from the trailer plug to the auxiliary lighting system to operate the auxiliary lighting system.
